(19) United States
(12) Patent Application Publication
(10) Pub. No.: US 2020/0040910 A1
(43) Pub. Date: Feb. 6, 2020

(54) STATOR BLADE UNIT FOR A TURBOMOLECULAR PUMP

(71) Applicant: Edwards Limited, Burgess Hill, West Sussex (GB)

(72) Inventors: Richard Glyn Horler, Burgess Hill, Sussex (GB); Paul Milner, Burgess Hill, Sussex (GB)

(21) Appl. No.: 16/469,468

(22) PCT Filed: Dec. 14, 2017
(86) PCT No.: PCT/GB2017/053748

§ 371 Date: Jun. 13, 2019

(30) Foreign Application Priority Data
Dec. 15, 2016 (GB) 1621368.8

(51) Int. Cl. F04D 29/54; F04D 19/04; F04D 29/38; B29C 45/14

(52) U.S. Cl. CPC F04D 29/542; F04D 19/042; B29L 2031/7498; B29C 45/14; F04D 29/388

(57) ABSTRACT

The present invention provides a stator blade unit for a turbomolecular pump comprising an array of polymer stator blades, a turbomolecular pump including such a stator blade unit, and to a method of assembling a stator blade unit for a turbomolecular pump.

### CROSS-REFERENCE OF RELATED APPLICATION

This application is a Section 371 National Stage Application of International Application No. PCT/GB2017/053748, filed Dec. 14, 2017, and published as WO 2018/109480 A1 on Jun. 21, 2018, the content of which is hereby incorporated by reference in its entirety and which claims priority of British Application No. 1621368.8, filed Dec. 15, 2016.

### FIELD

The present invention relates to a stator blade unit for a turbomolecular pump, a turbomolecular pump including such a stator blade unit, and to a method of assembling a stator blade unit for a turbomolecular pump.

### BACKGROUND

A turbomolecular pump generally comprises a rotor having a plurality of axially spaced, annular arrays of inclined rotor blades. The blades are regularly spaced within each array, and extend radially outwards from a central shaft. A stator of the pump surrounds the rotor, and comprises annular arrays of inclined stator blades which alternate in an axial direction with the arrays of rotor blades. Each adjacent pair of arrays of rotor and stator blades forms a stage of the turbomolecular pump. As the rotor rotates, the rotor blades impact incoming gas molecules and transfer the mechanical energy of the blades into gas molecule momentum, that is directed from the pump inlet through the stages towards the pump outlet.

It is common for the rotor of a turbomolecular pump to be assembled as a single piece, with the blades integral with the shaft. In this case, during pump assembly the arrays of stator blades are progressively assembled between the arrays of rotor blades. In one known assembly technique, each array of stator blades is divided into two semi-annular sections each comprising a semi-annular section in which the blades are supported radially by inner and outer portions. Starting towards the base of the rotor, the two semi annular sections which provide the first array of stator blades are radially inserted between the same two arrays of rotor blades so that the two semi annular sections form a continuous annular stator blade array. An annular spacer is then placed on the outer rim portion of the assembled annular stator blade array to axially separate that array from the next stator blade array to be assembled and prevent clashing between the rotor and stator blades. The two semi annular sections for forming the next stator blade array to be assembled are then inserted between the arrays of rotor blades so that one side of the outer rim portions of these sections rest upon the spacer.

Another annular spacer is then placed on the other side of the outer rim portion of that assembled stator blade array. This process continues until all of the stator blade arrays have been assembled to form a stator stack surrounding the rotor. A casing is then assembled about the stator stack, the stator stack being radially centred by the inner wall of the casing.

The compression ratio of the pump is dependent, inter alia, upon the number of arrays of rotor and stator blades, the number of blades within each array, the angle of inclination of the blades, and the rotational speed of the shaft. In order to enhance the inlet capacity of the turbomolecular pump, the sizes of the blades of the inlet stage of the pump, that is, the stage closest to the pump inlet, are generally relatively large, with the sizes of the blades of the stages gradually decreasing from the pump inlet towards the pump outlet. In other words, the axial lengths of the arrays of rotor and stator blades gradually decrease from the pump inlet towards the pump outlet. Likewise, the angle of the blades tends to decrease from the pump inlet towards the pump outlet.

Towards the pump outlet, where the axial lengths of the blades are relatively small, the semi-annular sections of the stator stack are generally formed from thin pieces of stainless steel or aluminium sheet material. The portions for the stator blades are defined by cutting the sheet material, and the blades are folded from the sheet material to a predetermined inclination either by cutting and pressing in a single step, or cutting and generating the profile in series of steps by press machining. Whilst pressing stators in this manner requires significant investment in tooling, manufacturing the piece parts is relatively low cost. However, the nature of the process makes the pressed part more flexible and can leave significant residual stresses in the pressed part. Consequently, internal pump clearances must be increased to accommodate this variation. Moreover, formation of the stator blade sections in this manner means that, within a single semi-annular section, no two blades may axially overlap.

Whilst this is not an issue when the required axial blade length is relatively small, towards the inlet of the pump, where the required axial blade length is relatively large, an alternative technique needs to be employed to manufacture the semi-annular blade sections so that adjacent blades may overlap. This can enable the number of stator blades within an array to be maintained throughout the stages of the pump.

One technique that is commonly used to manufacture the stator sections for at least the inlet stage of the pump is milling, in which the inclined stator blades and rim portions of the stator section are machined from a single piece of alloy. In comparison to press machining techniques, the milling process is relatively expensive; a milled stator section typically costs at least ten times as much as a machine pressed stator section.

There is therefore an ongoing need for improved stator arrays. In particular, there is a need for stator arrays that are more straightforward to manufacture; allow for the provision of more complex geometries; that are more reliable; can be produced to narrower tolerances; and at a reduced cost compared to pressing and/or machining alloy blades.

The present invention address these and other problems with known stator blade units.

The discussion above is merely provided for general background information and is not intended to be used as an aid in determining the scope of the claimed subject matter. The claimed subject matter is not limited to implementations that solve any or all disadvantages noted in the background.

### SUMMARY

Accordingly, in a first aspect the present invention provides a stator blade unit for a turbomolecular pump comprising an array of polymer and/or moulded stator blades comprising an inner rim and an outer rim adjoined to the array of stator blades, wherein the outer rim comprises an integrally formed spacer for preventing clashing between the stator blades and an adjacent rotor, and configured to engage with an axially adjoining stator array within a stator stack and wherein the stator blade unit comprises at least two sections, in the form of single unitary structures, arranged such that stator blades of one section are alternately arranged with stator blades of the at least one other section. Typically, the unit is substantially semi-annular with a circumferential array of equidistant, substantially co-planar stator blades. More typically, the stator blade unit is configured to couple with a second substantially semi-annular stator blade unit to form an annular stator blade array. In turn, said annular stator blade arrays may be configured such that a plurality of the annular arrays can be coupled together to form a stator blade stack within a turbomolecular pump.

Unlike machined or pressed alloy stator blades, the polymer and/or moulded stator blades per the invention allow the provision of more complex stator blade geometries and, advantageously, do not contain significant residual stresses following manufacture.

Non-metallic, polymer stator blades of the invention are significantly cheaper and easier to manufacture than known pressed or machined alloy blades. They allow the provision of more complex stator blade geometries and, advantageously, do not contain residual stresses following manufacture. Moreover, if a failure does occur, they are less likely to snag on rotor blades and cause the failure to be catastrophic.

The skilled person may select a suitable material based upon the exact geometries and the prevailing conditions found within a specific turbomolecular pump. In particular, the material may be selected so that the stator blade may be used at an operating temperature of between about 80° C. and about 110° C.

Advantageously, the material will have a coefficient of thermal expansion substantially the same as a turbomolecular pump's impeller material, more preferably within about 10 ppmK⁻¹ of the impeller material, more preferably from about 10 ppmK⁻¹ to about 50 ppmK⁻¹, more preferably from about 15 ppmK⁻¹ to about 45 ppmK⁻¹. When the impeller is made from aluminium a coefficient of approximately 23 ppmK⁻¹ is particularly preferred. Potentially, the coefficient of thermal expansion may be measured according to ASTM D1042-12.

The polymer may have a glass transition temperature greater than the operating temperature of the stator blade unit, preferably greater than about 110° C., more preferably greater than about 140° C. In use, the pump may be at a temperature of from about 90° C. to about 100° C. Typically the stator must be able to operate at least at such a temperature without suffering significant reduction in performance, in particular strength or stiffness. Typically, the below yield strengths are maintained at these temperatures. The properties of polymers as a function of temperature may potentially be measured per ASTMD1043-16. In the case of polymer stator blades, the polymer may have a tensile yield strength of greater than about 50 MPa, more preferably greater than about 75 MPa, more preferably from about 50 MPa to about 200 MPa, more preferably from about 75 MPa to about 150 MPa. The tensile testing of plastics may potentially be measured according to ASTM D638.

In the case of metallic stator blades, the alloy may have a yield strength of greater than about 50 MPa, more preferably greater than about 75 MPa. Advantageously metallic stator blades achieve these yield strengths at a temperature of greater than about 150° C. The tensile testing of metals may potentially be measured according to ASTM E8/E8M.

Unless otherwise stated measurements are made at 23° C.

Typically, the stator blades of the invention have a thickness of less than about 1 mm, preferably from about 0.1 mm to about 1 mm, preferably less than 0.5 mm, preferably less than about 0.3 mm.

Polymers suitable for use in the polymer stator blades of the invention may be selected from group consisting of elastomers, thermoplastic materials or thermosets. Thermoplastic materials are preferred and particularly those classified as high performance thermoplastic materials as a result of their mechanical and thermal properties. Preferred thermoplastics are selected from the group consisting of liquid crystal polymers, including aromatic polyamides and aromatic polyesters, aromatic polyimides, polyamides, polysulpones, polyethylenimines, and polyether ether ketone (PEEK), or derivatives or copolymers thereof.

The polymers may additionally include one or more from the group consisting antistatics, antioxidants, mould release agents, flameproofing agents, lubricants, colorants, flow enhancers, fillers, including nanofillers, light stabilizers and ultraviolet light absorbers, pigments, anti-weathering agents and plasticisers.

Additionally, or alternatively, the polymer stator blades may be polymer matrix composite stator blades. Preferably, wherein the polymer matrix accounts for at least about 50 wt % of the composite, more preferably from about 60 wt % to about 80 wt %. The polymer matrix composites may for instance be glass fibre or carbon fibre reinforced polymers, or metal powder reinforced polymers such as aluminium particle reinforced nylons, e.g alumide. Glass fibre reinforced polymers, such as glass fibre reinforced liquid crystal polymers, or glass fibre reinforced PEEK are particularly preferred. Preferably the fibre content is from about 10 wt % to about 50 wt %, preferably from about 20 wt % to about 40 wt %, preferably from about 25 wt % to about 35 wt %. Preferably, the polymer composite may be moulded, preferably injection moulded, or additive manufactured.

Metallic stator blades useful in the invention may comprise an alloy suitable for and/or subject to injection moulding and/or additive manufacturing. Such alloys are known to the skilled person. Injection moulded alloys may be selected from the group consisting of stainless steels, titanium alloys, nickel alloys and copper alloys. Additive manufactured alloys may be selected from the group consisting of stainless steels, titanium alloys, nickel alloys and aluminium alloys.

Additive manufacturing refers to a process or processes in which in which successive layers of material are laid down to form a three-dimensional object. Typically, the shape or geometry are produced from digital model data, 3D model or another electronic data source. Suitable additive manufacturing methods include fused deposition modelling, robocasting, stereolithography. digital light processing, powder bed and inkjet head 3D printing, electron-beam melting, selective laser melting, selective heat sintering, selective laser sintering, direct metal laser sintering, and directed energy deposition. The skilled person will be able to select an appropriate method depending on the stator material and/or stator unit geometry and/or stator unit function.

Outgassing may be problematic and so is preferably kept to a level which does not deleteriously affect turbomolecular pump performance. Preferably the stator material has a total mass loss, collected volatile condensable materials, and water vapour release each of less than about 1 wt %, more preferably less than about 0.5 wt %, more preferably less than about 0.1 wt %. Water absorption can be measured according ASTMD570.

In an aspect the invention provides a stator blade unit for a turbomolecular pump wherein the stator unit comprises an array of stator blades each comprising one or more inner layers and an outermost polymer layer, wherein the outermost polymer layer comprises a polymer that is less hard than a material forming one or more of the inner layers.

The polymer stator blades of the invention may comprise more than one polymer and in particular multiple polymer layers, each containing a different polymer. In embodiments, the stator blade may comprise one or more inner polymer layers and an outermost polymer layer, wherein the outermost polymer layer comprises a polymer that is less hard than the polymers forming the one or more inner layers. The outermost polymer layer may be over-moulded or otherwise coated onto the surface of the stator. The outermost polymer layer may substantially cover the inlet-side tip and/or outlet-side tip of the stator blades. In embodiments, metallic stator blades may have an outer polymer layer substantially covering the inlet-side tip and/or outlet side tip of the stator blades. Advantageously, if a pump malfunctions during use, abrasion of the outer/outermost polymer material may be detected in the outlet stream before the pump fails catastrophically. This may allow the recovery of a rotor blade that would otherwise have been rendered unusable.

The polymer of the outer/outermost polymer layer is typically a thermoplastic. Typically the polymer is selected from the group consisting of polyolefins, such as polyethylene and polypropylene; polyvinylchloride, polyethylene terephthalate; and fluoropolymers, such as polytetrafluoroethylene, and derivatives and copolymers thereof. Preferably an inner polymer layer has a Shore D hardness of greater than about 80. Preferably the outermost layer has a Shore D hardness of from about 10 to about 50. ASTM D2240 may be used to measure the hardness.

Coating the radially extending tip, or edge, rather than the face, of a stator blade with the outer/outermost polymer material is advantageous because doing so does not increase the thickness of the blade significantly, which would reduce pump performance. Accordingly, in a further aspect, the invention provides a stator blade unit for a turbomolecular pump comprising an array of stator blades wherein at least one stator blade has a polymer coated radially extending tip. Preferably, each stator blade has a polymer coated radially extending tip. Preferably, a majority of the stator blade face is free from the polymer coating.

In embodiments, the stator units may comprise an inner rim and/or an outer rim adjoined to the array of stator blades. The stator units of the invention may be formed from a single piece of material. Preferably the inner rim, outer rim and stator blades form a single unitary structure.

The mould for the stator blade units are advantageously formed such that the stator blade tip and root are flared axially along the point of adjoinment to the inner and/or outer rings. This enables the polymer to flow more easily into the mould and improves the strength of the unit.

The outer rim comprises an integrally formed spacer for preventing clashing between the stator blades and an adjacent rotor. Typically, during use, the spacer is configured to engage with an axially adjacent stator unit within a stator stack; more preferably, the spacer engages with the integrally formed spacer of a second stator blade unit according to the invention. Typically, the inlet-side transverse face and/or outlet-side transverse face of the integrally formed spacer is in a transverse plane that is further in an axial inlet direction and/or axial outlet direction than the plane of the inlet-side blade tips and/or outlet-side blade tips of the stator unit respectively. Blade tip may be understood to refer to an edge of the blade. Typically, the spacer(s) will provide a clearance of 2 mm or less between the stator blades of a unit and the blades of an adjacent rotor, preferably the clearance is from about 0.5 mm to about 2 mm, a clearance of about 1 mm is particularly preferred.

By eliminating the need for separate spacers, integrating the spacer in the stator unit advantageously reduces the number of parts in the stator stack, thereby reducing the tolerance stack within the turbomolecular pump. In embodiments this allows lower clearances to be employed and smaller pumps to be manufactured. Accordingly the invention provides a stator blade unit for a turbomolecular pump comprising an array of stator blades and an outer rim, wherein the outer rim comprises an integrally formed spacer for preventing clashing between the stator blades and an adjacent rotor.

When part-annular arrays are arranged to form an annular array, typically, axial joints are located between the adjoining parts of the array. When a separate spacer is employed the spacer may span the joint and prevent direct leakage therealong. However, when an integrally formed spacer is employed an axial joint may be located in the spacer itself. It is therefore preferable for the axial joints of arrays within a stator stack to be circumferentially off-set. It is particularly preferable for the joints between adjacent semi-annular arrays to be circumferentially offset, typically by from about 45 degrees to about 90 degrees. In this way, a transverse face of the outer rim, or integrally formed spacer, may be configured to bridge the axial joint(s) of adjacent stator arrays within the stator stack. This is advantageous because it limits direct leak paths through the stator stack, improving pump performance.

The part-annular arrays advantageously are provided with cooperating joining mechanisms at the circumferential ends of the outer rims for cooperating to join the part annular arrays to form annular arrays.

If an annular stator unit comprises two semi-annular arrays, each semi-annular array comprising two or more sections as described above, it is advantageous for each section to comprise a cooperating joining mechanism at both circumferential ends of the outer rims of each section.

The cooperating joining mechanisms further prevent leak paths from being formed at the joints between part annular arrays.

Additionally, or alternatively, a first integrally formed spacer may be configured to have an interference engagement with an adjacent second integrally formed spacer within a stator stack. Adjacent stator units may be coupled together using mechanical, and, preferably, non-permanent, coupling means. Additionally, or alternatively, the units may be permanently or semi-permanently bonded together, for instance using an adhesive, heat-staking or ultrasonic welding.

Typically, a snap-fit assembly, preferably a cantilever snap-fit assembly, is located on the integrally formed spacer and is employed to couple axially adjacent stator units within a stator stack: preferably, wherein the interlocking components of the snap-fit assembly are located i) at or adjacent to an axial-joint-bridging portion of a first stator array's integrally formed spacer and ii) adjacent to an axial-joint of a second stator array's integrally formed spacer. This arrangement further reduces the likelihood of a direct leak along the axial joint.

Preferably, the inner rim of a first stator array unit is configured to couple with an inner rim of at least a second stator blade unit. In use, each inner rim may be configured to couple with an axially adjacent stator blade unit, typically with the inner rims of axially adjacent stator units within the stator stack. The means for coupling may be mechanical and, preferably, non-permanent to allow the replacement of stator units within the turbomolecular pump. Preferably, the means for coupling is a snap-fit assembly. Additionally, or alternatively, the inner rims may be permanently or semi-permanently bonded together, for instance using an adhesive, heat-staking or ultrasonic welding.

Additionally, or alternatively, if a stator unit comprises two or more sections, the inner rims of the sections forming the unit may be coupled together. In all instances, snap-fit assemblies are particularly preferred, typically an annular snap-fit assembly or cantilever snap-fit assembly. Alternatively, the sections' inner rims may be permanently or semi-permanently bonded together, for instance using an adhesive, heat-staking or ultrasonic welding.

The two or more sections making up a part-annular stator unit can be coupled together using interlocking mechanisms at both circumferential ends of the inner rims of each section. The interlocking mechanism of two axial sections of a part annular stator unit may, when interlocked, form cooperating connection mechanisms for cooperating to connect part-annular stator units to form an annular stator unit.

Coupling the inner rims of stator units advantageously increases the stiffness of a stator stack, allowing internal pump clearances to be reduced, improving pump performance and reducing the height of overall assembly.

Additionally, or alternatively, if an annular stator unit comprises two semi-annular units, each semi-annular unit comprising two or more sections as described above, it is advantageous to use four identical sections, formed in the same mould, such that each semi-annular unit is formed from two identical sections with one section orientated in the inverted position upon the transverse face of the other section such that the stator blades of one section are alternately arranged with stator blades of the at least one other section. This reduces the number of moulds, or tooling, required for each stator unit and eliminates build errors.

The stator blade cross sectional shape is advantageously mirrored around its centreline between the inner and outer rims such that the blade performance is substantially the same in either orientation.

Typically, stator arrays vary in geometry along the length of the stack, with stator blades progressively reducing in size and angle from one array to the next from the inlet towards the outlet of the pump. Advantageously, the stator arrays are identifiable and locatable within the stack as a result of reference points on each stator.

When employed, snap-fit assemblies on the inner and/or outer rim may be employed as one or more reference points to facilitate the collocation of stator blade arrays in a stator blade stack, in particular aiding the identification and ordering of stator arrays within the stack. To this end, preferably the reference points are located in different respective locations relative to the stator blades on each stator blade array.

Preferably the stator blade unit is additive manufactured or moulded, including but not limited to spin-casted, injection moulded and 3D printed. Advantageously, additive manufactured and/or moulded stator blades do not contain significant residual stresses, reducing deformation and allowing internal pump clearances to be reduced, improving pump performance and reducing the overall height of the assembly.

In embodiments of the invention the stator blades axially overlap. This is advantageous because axially opaque stator arrays provide better compression performance.

In embodiments of the invention it is advantageous for the stator blade unit to be formed from at least two sections. Typically, the stator blades are positioned one over the other so that stator blades of one section are alternately arranged with stator blades of the other section. Nesting the stator blades in this manner allows for more straightforward manufacture of axially overlapping stator blades, particularly for injection moulded units where sliding or rotatable tools may not be appropriate.

Typically, each section will comprise an inner rim, an array of stator blades, and an outer rim. The outer rims of the sections may form of an integrally formed spacer. For the avoidance of doubt, features of the integrally formed spacers disclosed earlier in this application may equally be applied to the integrally formed spacers of nested embodiments of the invention. Equally, interlocking inner and outer rims may be employed. Each section may be made from a single piece of material. Typically, each section is in the form of single unitary structure. Preferably, the sections interlock to form a more rigid stator unit, preferably at least one snap-fit is employed, preferably an annular or cantilever snap-fit.

The two or more axial sections making up a part-annular stator unit can be coupled together using interlocking mechanisms. The interlocking mechanism of two axial sections may, when interlocked, form connection mechanisms for cooperating to connect with another part-annular stator units.

The integrally formed spacer may be evenly split between the first and second sections of the same unit. Alternatively, the integrally formed spacer may be predominantly located on one of the outer rims of the first or second sections of the same unit.

In some embodiments comprising two or more sections, it is envisaged that only one of the sections outer rims may be configured to engage with the integrally formed spacer(s) of an adjacent stator unit. In particular, one or more bosses located on the outer rim of a first section may be configured to protrude through one or more corresponding apertures in an outer rim of a second section of the unit so as to engage with the integrally formed spacer of an adjacent stator unit. This arrangement reduces the tolerance stack of the stator stack.

The stator blades of the invention may have any suitable surface roughness and preferably from about 0.01 μm and about 5.0 μm when measured on an SEM. Preferably, the surface roughness of the stator blades is greater than about 1.5 μm.

In an aspect, the invention provides a stator blade unit for a turbomolecular pump comprising an array of stator blades, each stator blade having a surface with a roughness of greater than about 1.5 μm, preferably an inlet-side face and/or outlet-side face.

An increase in stator blade roughness has been found to provide improved pump performance.

A further aspect of the invention provides a stator blade unit for a turbomolecular pump comprising an array of stator blades, each stator blade having an inlet-side face and outlet-side face, wherein surface roughness of the outlet-side face is different to the surface roughness of the inlet-side face, preferably the roughness of the outlet-side face is greater. Preferably the inlet-side face has a surface roughness of <1.5 μm, preferably less than about 1 μm, and outlet-side face has a roughness of 21.5 μm, preferably from about 1.5 μm to about 5 μm. This has been found to provide further improvement to pump performance compared to arrangements where both stator faces have the same roughness.

In further aspects the invention provides a stator blade stack comprising at least one state blade unit according to the other aspects of the invention, and a turbomolecular pump comprising at least one stator blade unit according to any preceding aspect of the invention.

In a further aspect the invention provides a method of manufacturing a stator blade unit for a turbomolecular pump according to the other aspects of the invention. In particular, the method may comprise the step of moulding or additive manufacturing an array of stator blades. An inner rim and/or outer rim may be co-moulded or co-formed by additive manufacture with the polymer stator blades, preferably to form a single unitary structure. Additionally, or alternatively, the outer rim may comprise an integrally formed spacer for preventing clashing between the polymer stator blades and an adjacent rotor. Accordingly, the invention provides a method of manufacturing a stator blade unit for a turbomolecular pump comprising the step of moulding a single unitary structure comprising an array of polymer or metallic stator blades.

A further aspect of the invention provides a stator unit for a turbomolecular pump comprising an array stator blades and an integrally formed spacer for preventing clashing between the stator blades and an adjacent rotor, wherein the stator blades and integrally formed spacer are injection moulded and/or additive manufactured.

In a further aspect, the invention provides method of assembling a turbomolecular comprising at least one annular stator array, the annular stator array comprising an array of stator blades, typically machined or pressed metallic stator blades, and, optionally, at least one metallic spacer ring. The method comprising the steps of removing the one or more annular stator arrays from the stator stack and replacing the one or more removed annular stator arrays with one or more annular stator arrays comprising an array of polymer stator blades, or additive manufactured or injection moulded metallic stator blades. Preferably, wherein one or more metallic stator spacer rings are also removed from the stator stack, and wherein the replacement annular stator array(s) comprise an integrally formed spacer.

For the avoidance of doubt, all aspects and embodiments described hereinbefore may be combined mutatis mutandis.

The Summary is provided to introduce a selection of concepts in a simplified form that are further described in the Detail Description. This summary is not intended to identify key features or essential features of the claimed subject matter, nor is it intended to be used as an aid in determining the scope of the claimed subject matter.

### BRIEF DESCRIPTION OF THE DRAWINGS

Preferred features of the present invention will now be described, by way of example, with reference to the accompanying drawings, in which:

FIG. 1 shows a two-part semi-annular stator array according to the invention.

FIG. 2 shows an annular stator array according to the invention.

FIG. 3 shows a stator stack according to the invention.

FIG. 4 shows a stator stack according to the invention in-situ.

FIGS. 5a and 5b show snap-fit outer rim coupling.

FIG. 6 shows a snap-fit inner rim coupling.

FIGS. 7a and 7b shows an interlocking inner rim coupling

FIGS. 8a and 8b shows an outer rim coupling and identical sections

FIG. 9 shows symmetrical blades and moulding according to the invention

### DETAILED DESCRIPTION

The invention provides a stator unit 1 for a molecular pump comprising an array of polymer stator blades 2. In this example, the stator blade unit 1 is formed from at least two curved sections 3, 4 of polymer material. A suitable polymer is Vectra® E130i a composite comprising glass fibre reinforced liquid crystal polymer. The curved sections 3, 4 are semi-annular, so that two stator blade units 1 are required to form an annular array 5 of stator blades 2.

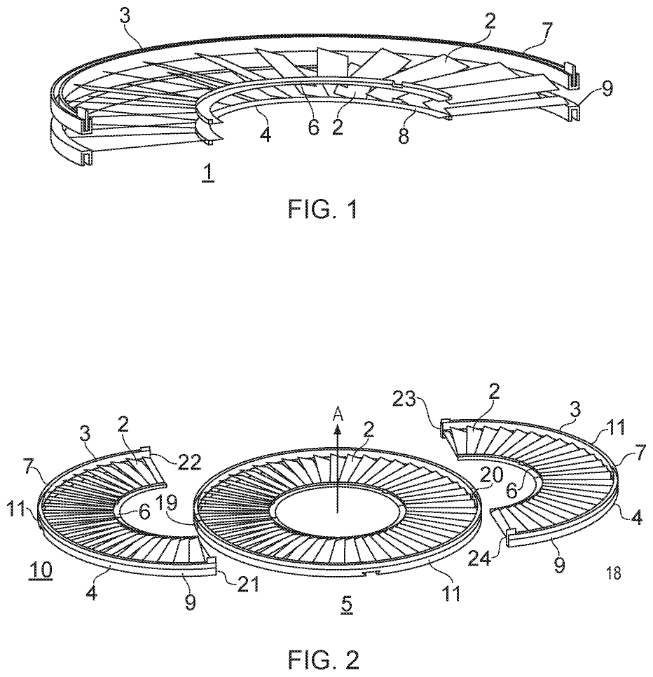

With reference to FIG. 1 moulded or additive manufactured polymer stator blades are provided in two curved sections 3, 4. The two curved sections 3, 4 are of substantially the same size and width. Each section 3, 4 defines a series of regularly spaced stator blades 2. The stator blades 2 of both curved sections 3, 4 are substantially the same length, preferably such that when the sections 3, 4 are nested together their inlet-side blade tips are substantially coplanar and their outlet-side blade tips are substantially coplanar. Typically, the stator blades 2 of the outlet-side curved section 4 protrude axially from their inner rim 8 and outer rim 9 in an inlet-direction, whereas the stator blades of the inlet-side curved section 3 protrude axially from their inner rim 6 and outer rim 7 in an out-let direction. Preferably the angular pitch of the stator blades is substantially the same on both curved sections 3, 4.

As shown in the example in FIG. 9, the stator blade tip and root can be moulded to flare axially along the point of adjoinment 41 to the inner and/or outer rims 6, 7, 8, 9. This enables the polymer to flow more easily into the mould and improves the strength of the unit

The first and second curved sections 3, 4 may be brought together by inserting the stator blades of the second curved 3 section through the apertures of the first curved section 4, and vice-versa, until the inner 6 and outer rims 7 of the first curved section 3 overlay the inner 8 and outer 9 rims respectively of the second curved section 4. Accordingly, as shown in FIG. 2, an array 10 of stator blades is formed, in which the stator blades of the first curved section 3 are circumferentially alternately arranged with the stator blades of the second curved section 4. As illustrated in FIG. 2, adjacent blades may overlap. Where axial overlap is desirable, such as in the compressive stages nearer the pump outlet, preferably, the stator array is axially opaque. That is to say, no spaces are visible between the stator blades when the unit is viewed directly from above or below.

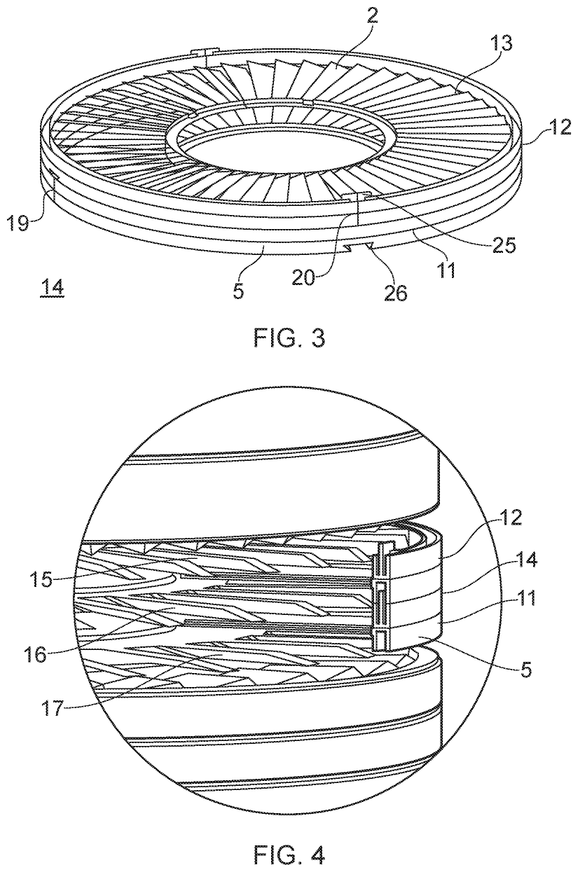

As illustrated in FIG. 2, the exemplified stator unit comprises an integrally formed spacer 11. In the example, the one curved section 3 outer rim 7 provides an upper portion of the integrally formed spacer 11, whereas the other curved section 4 provides a lower portion 9 of the integrally formed spacer 11. As shown, in FIGS. 3 and 4, in use, the integrally formed spacer 11 of a first annular stator array 5 engages with the integrally formed spacer 12 of at least one adjacent stator unit 13.

When a stator array stack 14 is assembled the integrally formed spacers 11, 12 hold the stators in position relative to the impeller rotors 15, 16, 17 and prevent engagement therebetween. Typically, during use, there is a nominal clearance of about 1 mm between the stator blades of an annular array 5 and the blades of an adjacent rotor 17 within the molecular pump, preferably the maximum clearance is from about 0.5 mm to about 2 mm. The polymer is selected to ensure that stator array 5 does not contact with the rotors 17 of the molecular pump during use.

As shown in FIG. 2, the semi-annular stator units 10, 18 couple to form an annular stator array 5. In the exemplified embodiment, because the spacer 11 is integrally formed, there are axial mating surfaces 21, 22, 23, 24 which mate at the joints 19, 20 between the first 18 and second 10 stator units. To mitigate direct leaking along the mating surfaces 21, 22, 23, 24, the stator units employ a snap-fit assembly to tightly engage the adjacent spacer rings and substantially seal the joint 19, 20.

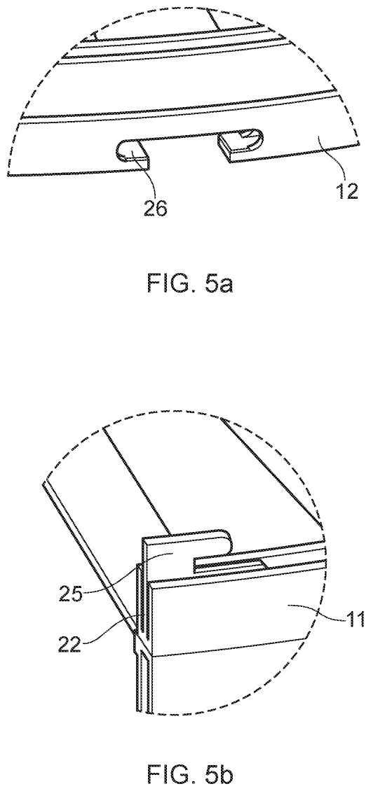

As illustrated in more detail in FIGS. 5a and 5b, a protruding male portion 25 from a first integrally formed spacer 11 mates with a corresponding female portion 26 on the integrally formed spacing ring 12 of an adjacent stator array. Additionally, or alternatively, as illustrated in FIG. 3, the joints 19, 20 of adjacent stator arrays may be circumferentially offset, in this instance by approximately 90 degrees. This too mitigates the risk of direct leakage along the axial joints 19, 20.

By varying the circumferential off-set between the joints 19, 20 of successive annular stator arrays within the stack 14, the joints 19, 20, and/or associated snap-fit assemblies 25, 26, may advantageously be used as a reference point for positioning stator arrays 5 within the stator stack 14. In the illustrated example in FIG. 5b only a first portion of a male engagement structure 25 is adjacent mating surface 22 on the unit. A second portion of the same male engagement structure is located adjacent the corresponding mating surface on the second unit forming the remainder of the annular array.

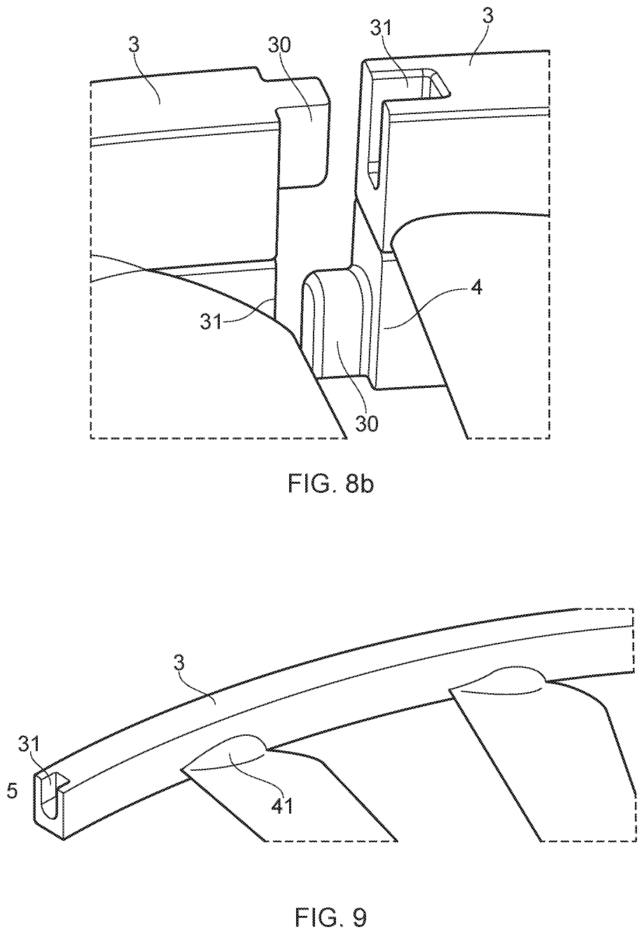

As shown in FIGS. 8a and 8b the annular stator unit can be formed from two semi-annular units, each semi-annular unit comprising two or more sections 3, 4. In the example illustrated the sections 3, 4, 4, 3 are all identical sections, formed in the same mould, such that each semi-annular unit is formed from two identical sections 3, 4 with one section orientated in the inverted position upon the transverse face of the other section such that the stator blades 2 of one section are alternately arranged with stator blades 2 of the at least one other section.

To facilitate the use of identical sections 3, 4, as shown in FIG. 9 the cross-sectional shape of the stator blades in the identical sections is mirrored, i.e. substantially symmetrical, around its centreline between the inner and outer rims such that the blade performance is substantially the same in either orientation of the sections 3, 4.

Each section 3, 4 also has a cooperating connection mechanism 30, 31, at the circumferential end of the outer rims 7, 9. In the example shown the mechanism 30, 31 is in the form of a peg 30 and hole 31 type connection, but other connection mechanism are possible, such a dove tails. Each section 3, 4 has a peg 30 at one circumferential end and a hole 31 at the other circumferential end, such that when the two semi-annular arrays, each comprising sections 3,4 are brought together to form an annular array, the cooperation of each peg 30 being received by a hole 30, provides an additional degree of strength to the annular array. In addition, the cooperating connection mechanism 30, 31 also provides an additional seal to prevent the migration of gas axially between the joints formed between semi-annular arrays.

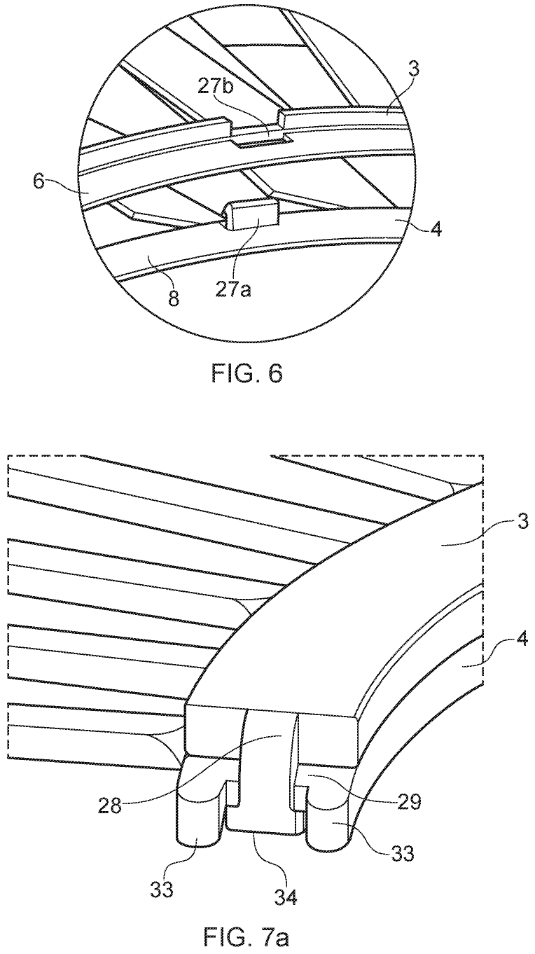

FIG. 6 illustrates a snap-fit assembly 27a, 27b located on the inner rims 6, 8 of a stator unit. In the example, the snap-fit 27a, 27b connects two curved sections 3, 4 of the same stator unit. As explained elsewhere in the application, physically connecting the inner rims 6, 8 improves the stiffness of the array, thereby reducing deflection during use. In particular, it reduces deflection as a result of the spring (not shown) commonly used to hold the stator stack in place within the molecular pump. Improving the stiffness of the stator is advantageous as it allows closer association of the molecular pumps components, improving pump performance.

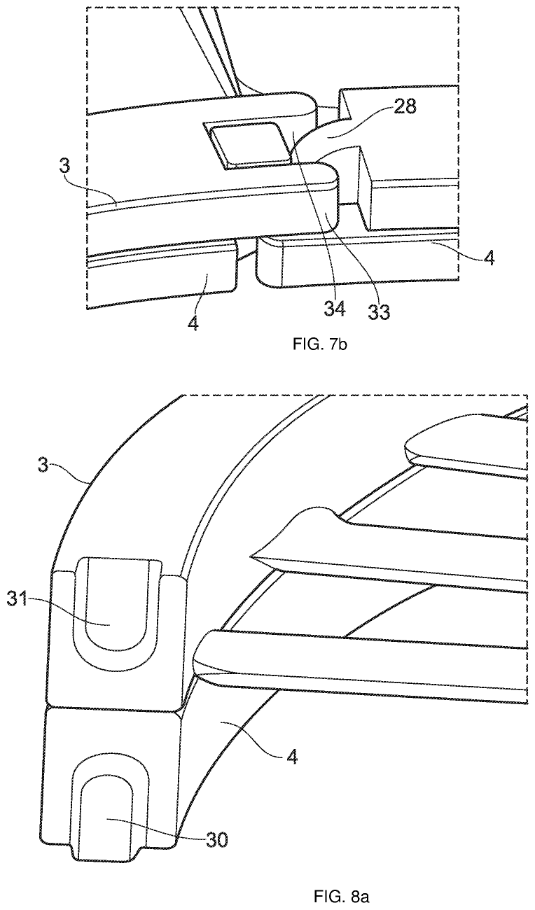

As shown in FIGS. 7a and 7b, the inner rims 6, 8 of two interesting sections 3, 4 of a part annular stator unit can be coupled together using interlocking mechanism 28, 29, 33 located at the circumferential ends of each section 3, 4. In the example shown the interlocking mechanism 28, 29, 33, of the sections 3, 4 when coupled together, form a connection mechanism 28, 34 in the form of a circumferentially extending protrusion 28 and circumferential receiving opening 34 on the sections 3 and 4 of a semi-annular unit respectively. When two semi-annular units, both comprising sections 3 and 4, joined together with the mechanism 28, 29, 33, the connection mechanism 28, 34 of one semi annular unit cooperate with the connecting mechanism 34, 28 of the other semi annular unit respectively.

It will be appreciated that various modifications may be made to the embodiments shown without departing from the spirit and scope of the invention as defined by the accompanying claims as interpreted under patent law.

Although elements have been shown or described as separate embodiments above, portions of each embodiment may be combined with all or part of other embodiments described above.

Although the subject matter has been described in language specific to structural features and/or methodological acts, it is to be understood that the subject matter defined in the appended claims is not necessarily limited to the specific features or acts described above. Rather, the specific features and acts described above are described as example forms of implementing the claims.

1. A stator blade unit for a turbomolecular pump comprising:
an array of polymer and/or moulded stator blades comprising an inner rim and an outer rim adjoined to the array of stator blades, wherein the outer rim comprises an integrally formed spacer for preventing clashing between the stator blades and an adjacent rotor, and configured to engage with an axially adjoining stator array within a stator stack and wherein the stator blade unit comprises at least two sections, in the form of single unitary structures, arranged such that stator blades of one section are alternately arranged with stator blades of the at least one other section.

2. The stator blade unit according to claim 1 wherein the stator blades axially overlap.

3. The stator blade unit according to claim 1 wherein the inner rim is configured to couple with an inner rim of another stator blade unit.

4. The stator blade unit according to claim 1 wherein the stator blade unit is injection moulded or additive manufactured, preferably an injection moulded polymer and/or metal stator blade unit.

5. The stator blade unit according to claim 1 wherein the stator blade unit comprises polymer stator blades each comprising one or more inner polymer layers and an outermost polymer layer, wherein the outermost polymer layer comprises a polymer that is less hard than the polymer forming the one or more inner layers.

6. The stator blade unit according to claim 1 wherein the stator blade unit is substantially semi-annular.

7. The stator blade unit according to claim 6 wherein the stator blade unit is configured to mate with a second substantially semi-annular stator blade array to form an annular stator blade array.

8. The stator blade unit according to claim 1 wherein each stator blade comprises an inlet-side face and an outlet-side face and wherein the inlet-side face has a different roughness to the outlet-side face.

9. A method of manufacturing a stator blade unit for a turbomolecular pump comprising the step of injection moulding a single unitary structure comprising an array of stator blades wherein an inner rim and/or outer rim are co-moulded with the stator blades, and wherein the outer rim comprises an integrally formed spacer for preventing clashing between the stator blades and an adjacent rotor.

10. The method according to claim 9 wherein injection moulding a unitary structure comprises: injection moulding a first structure comprising an array of stator blades, injection moulding a second structure comprising an array stator blades, and combining the first and second structures to form a stator blade unit.

11. The method according to claim 10 wherein, when combined, the stator blades of the first structure are alternately arranged with stator blades of the second structure.

12. The method according to claim 9 wherein the stator blades overlap.

13. A stator blade unit manufactured according to or obtainable by the method of claim 9.

14. A stator blade unit for a turbomolecular pump wherein the stator unit comprises an array of stator blades each comprising one or more inner layers and an outermost polymer layer, wherein the outermost polymer layer comprises a polymer that is less hard than a material forming one or more of the inner layers.

15. A stator blade unit for a turbomolecular pump comprising a fluid substrate moulded or additive manufactured unitary structure comprising an array of stator blades and an outer rim, wherein the outer rim comprises an integrally formed spacer for preventing clashing between the stator blades and an adjacent rotor, said blade unit comprising at least two sections each comprising an array of stator blades arranged such that stator blades of one section are alternately arranged with stator blades of the at least one other section.

16. The stator blade unit according to claim 15 wherein the sections are single unitary structures.

17. The stator blade unit according to claim 15 wherein adjacent stator blades overlap.

18. A stator blade unit for a turbomolecular pump comprising an array of stator blades wherein a stator blade has a polymer coated edge.

19. A turbomolecular pump comprising at least one stator blade unit according to claim 1.

20. (canceled)
